(19) United States
(12) Patent Application Publication
(10) Pub. No.: US 2019/0227329 A1
(43) Pub. Date: Jul. 25, 2019

(54) WEARABLE DEVICE

(71) Applicant: LG ELECTRONICS INC., Seoul (KR)

(72) Inventors: Jongbeom HAN, Seoul (KR); Sanghyuk IM, Seoul (KR); Sunglyong CHA, Seoul (KR); Haklim LEE, Seoul (KR)

(73) Assignee: LG ELECTRONICS INC., Seoul (KR)

(21) Appl. No.: 16/327,715

(22) PCT Filed: Aug. 23, 2016
(86) PCT No.: PCT/KR2016/009321

§ 371 Date: Feb. 22, 2019

(51) Int. Cl. G02B 27/01

(52) U.S. Cl. CPC G02B 27/0176; G02B 27/0172; G02B 2027/014; G02B 2027/0169; G02B 2027/0163; G02B 27/0179

(57) ABSTRACT

The present invention comprises a ring-shaped headband; a main body which is coupled to one side of the headband; an image output unit which is mounted on the main body to provide images to a user; and a hinge unit which is located between the main body and the headband. The main body rotates around the hinge unit whereby the wearable device selectively covers the user's eyes. Accordingly, it is possible to easily secure a field of vision and minimize inconvenience due to attachment and detachment.

### FIELD

The present invention relates to a wearable device which may transmit virtual real information, with improved usability.

### BACKGROUND

Terminals may be generally classified as mobile/portable terminals or stationary terminals according to their mobility. Mobile terminals may also be classified as handheld terminals or vehicle mounted terminals according to whether or not a user can directly carry the terminal.

Mobile terminals have become increasingly more functional. Examples of such functions include data and voice communications, capturing images and video via a camera, recording audio, playing music files via a speaker system, and displaying images and video on a display. Some mobile terminals include additional functionality which supports game playing, while other terminals are configured as multimedia players. More recently, mobile terminals have been configured to receive broadcast and multicast signals which permit viewing of content such as videos and television programs.

As there is a rising interest in wearable devices for ease of usability, researches and studies are ongoing about glasses types, bracelet types, watch types and other diverse types of mobile terminals.

A head-mount display device among wearable devices which is wearable on the user's face to provide visual information is taking a center stage together with diverse contents using virtual reality which are under development.

The wearable device which provides a virtual reality based image is usually put on the user's face in close contact like goggles to shut off external light so that the user cannot see the outside. Accordingly, the user has to take off the wearable device to secure a clear view and it is difficult to put on or take off the wearable device only to cause discomfort in use.

### DETAILED DESCRIPTION OF THE INVENTION

### Technical Problem

To overcome the disadvantages, an object of the present invention is to address the above-noted and other problems and to provide a wearable device which enhances wearing sensation by compensating different shapes of the users' heads and usability by facilitating easy view securement if necessary.

### Technical Solution

To achieve these objects and other advantages and in accordance with the purpose of the embodiments, as embodied and broadly described herein, a wearable device comprises a head body formed in a ring shape; a main body coupled to one side of the head band; an image output unit loaded in the main body and configured to provide a user with an image; and a hinge unit provided between the main body and the head band, wherein the main body is rotatable with respect to the hinge unit and selectively covers the user's eyes.

The hinge unit may comprise a elastic member provided to supplement the rotation of the main body when the main body is rotated in a first direction that becomes farther from the user's eyes.

The hinge unit may comprise a hinge head coupled to one of the head band and the main body; a hinge shaft extended from the hinge head; a washer coupled to the hinge shaft and movable along a direction of the hinge shaft; a hinge housing coupled to the other one of the head band and the main body and having the hinge shaft and the washer arranged therein; a elastic member provided in the hinge housing and having one side that faces the hinge housing and the other side that faces a cam member; a cam line formed in the hinge housing in an oblique groove shape; and a hooking protrusion projected from an outer surface of the washer and provided to be inserted in the cam line and move along the cam line, and the length of the elastic member is adjustable while the washer is moving along the hinge shaft as the location of the hooking protrusion is changed in the cam line.

The cam line may comprise a first area and a second area having an inclined surface with a continuous surface and a hooking groove, and when the hinge unit is rotated in a first direction, the location of the hooking protrusion is changed from the first area into the second area, and when the hinge unit is rotated in a second direction that is opposite to the first direction, the location of the hooking protrusion is changed from the second area into the first area.

The hinge unit may comprise a hinge head coupled to one of the head band and the main body; a hinge shaft extended from the hinge head; a hooking protrusion projected from the hinge shaft; a hinge housing coupled to the other one of the head band and the main body and having the hinge shaft and the washer arranged therein; a cam member comprising an inclined surface formed in a surface contacting with the hooking protrusion and movably coupled to the hinge housing along the hinge shaft; and a elastic member provided in the hinge housing and having one side that faces the hinge housing and the other side that faces a cam member, and the length of the elastic member is adjustable while the cam member is moving along the hinge shaft as the location of the hooking protrusion is changed in the inclined surface of the cam member.

The cam member may have a disc-shape having the inclined surface formed in one surface of the cam member and the elastic member coupled to the other side, and a hinge hole may be formed in a center of the cam member to allow the hinge shaft to penetrate.

The inclined surface of the cam member may comprise a first area that is high in a direction of one surface and a second area that is low, and when he hinge unit is rotated in a first direction, the location of the hooking protrusion may be changed from the first area into the second area, and when the hinge unit is rotated in a second direction that is opposite to the first direction, the location of the hooking protrusion may be changed from the second area into the first area.

The cam member may comprise an inclined surface having a continuous surface and a hooking groove, and the hooking groove is formed in at least one of the first and second areas.

One or more hooking grooves may be additionally formed between the first area and the second area.

The wearable device further comprises a proximity sensor provided in the main body and configured to sense whether the user's face is located near the main body; and a controller implemented to control image output unit to pause image output unless the proximity sensor senses the user's face and to continue the image output when the proximity sensor senses the user's face.

The wearable device may further comprise a first sliding member coupled to one of the main body and the hinge unit; and a second sliding member coupled to the other one of the main body and the hinge unit, wherein the second sliding member is able to relatively slide with respect to the first sliding member in a third direction.

The wearable device may further comprise a hook formed in the first sliding member; and a plurality of hook grooves formed in the second sliding member and arranged in the third direction, wherein when the user applies a force to the main body in the third direction, the hook is coupled to one neighboring one of the hook grooves and moves in the third direction.

The head band may further comprise a first band; a second band; and a length adjusting unit provided to adjust a gap between the first band and the second band, and the length adjusting unit comprises, a rack gear coupled to one or more of the first and second bands; and a pinion gear provided to engage with the rack gear and configured to convert the rotation motion into a linear motion.

The rack gear may comprise a first rack gear coupled to the first band and one side of the pinion gear; and a second rack gear coupled to the second band and the other side of the pinion gear, and the first rack gear and the second rack gear are movable in symmetry.

The length adjusting unit may further comprise a button unit projected from one surface of the pinion gear and exposed outside the head band; and a spring provided in the other surface of the pinion gear, and when the user presses the button unit, the pinion gear may be separated from the rack gear and the length of the head band is increased, and unless the user presses the button unit, the pinion gear may be re-coupled to the rack gear by the elasticity of the spring.

The wearable device may further comprise a flexible pad that is detachable from the head band.

The flexible pad comprises a Velcro that is detachable from the head band; a flexible foam having elasticity; and a fabric pad provided to contact with the user's forehead.

### Advantageous Effects

Accordingly, the embodiments have following advantageous effects. The wearable device according to at least one embodiment of the present disclosure is capable of minimizing the discomfort of the putting on or taking off process by the easy view securement.

Furthermore, the wearable device is capable of adjusting the size of the head band according to the size of the user's head and preventing external light from disturbing the image viewing by being worn on the user's face in close contact. Accordingly, the sense of wearing may be enhanced.

Further scope of applicability of the present invention will become apparent from the detailed description given hereinafter. However, it should be understood that the detailed description and specific examples, while indicating preferred embodiments of the invention, are given by illustration only, since various changes and modifications within the spirit and scope of the invention will become apparent to those skilled in the art from this detailed description.

### BRIEF DESCRIPTION OF THE DRAWINGS

FIG. 1 is a block diagram to describe a wearable device related to the present invention;

FIG. 2 is a perspective diagram illustrating the wearable device;

FIG. 3 is a side view illustrating a state where a user is wearing a conventional wearable device and a state where a user is wearing the wearable device according to the present invention;

FIG. 4 is a perspective diagram illustrating a length adjusting unit provided in the wearable device;

FIG. 5 is a diagram illustrating the structure that a main body of the wearable device is moving in a horizontal direction;

FIG. 6 is a diagram illustrating a sliding unit of the wearable device;

FIG. 7 is a diagram illustrating one embodiment of the main body which is rotating along the movement of a hinge unit;

FIG. 8 is a perspective diagram illustrating one embodiment of the hinge unit provided in the wearable device;

FIG. 9 is a diagram illustrating a location relation between a hooking protrusion and a cam member according to the embodiment of the hinge unit;

FIG. 10 is a perspective diagram illustrating another embodiment of the hinge unit;

FIG. 11 is a diagram illustrating a location relation between a hooking protrusion and a cam member according to another embodiment of the hinge unit; and

FIG. 12 is a diagram illustrating a forehead pad provided in the wearable device.

### DESCRIPTION OF SPECIFIC EMBODIMENTS

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function.

In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

It will be understood that although the terms first, second, etc. may be used herein to describe various elements, these elements should not be limited by these terms. These terms are generally only used to distinguish one element from another.

It will be understood that when an element is referred to as being “connected with” another element, the element can be directly connected with the other element or intervening elements may also be present. In contrast, when an element is referred to as being “directly connected with” another element, there are no intervening elements present.

A singular representation may include a plural representation unless it represents a definitely different meaning from the context.

Terms such as “include” or “has” are used herein and should be understood that they are intended to indicate an existence of several components, functions or steps, disclosed in the specification, and it is also understood that greater or fewer components, functions, or steps may likewise be utilized.

A conventional mobile terminal has a telephone function as a basic function. However, a recent mobile terminal refers to a portable device having a multimedia function as well as a telephone function. Examples of the mobile terminal may be expanded even to a wearable device which is wearable on the human body part over a portable device which is handheld. Examples of such a wearable device include a smart watch, smart glasses and HMD (Head Mounted Display).

The wearable device may transceive data (or be linked) with another mobile terminal. A short range communication module may sense (or recognize) a communicable wearable device near the mobile terminal. Moreover, a control unit may transmit at least predetermined amount of the data processed in the mobile terminal via the short range communication module, when the sensed wearable device is an authenticated one to allow communication with the mobile terminal. Accordingly, the user is able to use the data processed in the mobile terminal via the wearable device. For example, when a call is received in the mobile terminal, the user is able to answer the call via the wearable device or when a text message is received in the mobile terminal, the user is able to check and read the received text message via the wearable device.

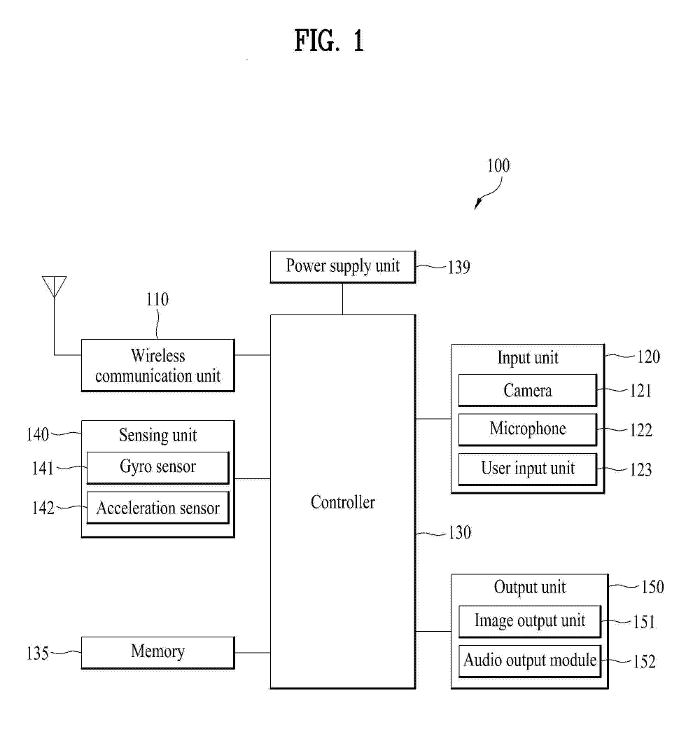

FIG. 1 is a block diagram of a mobile terminal in accordance with the present disclosure. The mobile terminal 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components in The FIG. 1 is not a requirement, and that greater or fewer components may alternatively be implemented.

Hereinafter, the components will be described in order.

The wireless communication unit 110 may include one or more modules configured to facilitate wireless communication between the wearable device 100 and a wireless communication system or a network in which the wearable device 100 is located. As one example, the wireless communication unit 110 may include a mobile terminal module, a wireless communication unit, a wireless internet module, a short range communication module and a location information module.

The mobile communication module may transceive a wireless signal with one or more of a base station, an external terminal and a server on a mobile communication network such as GSM (Global System for Mobile communications), CDMA (Code Division Multiple Access), WCDMA (Wideband CDMA) (the present invention is not limited thereto). The wireless signal may include divers types of data according to transceiving of a voice call signal, a video call signal or a text/multimedia message.

The wireless internet module means a module for wireless internet and it may be embedded in or mounted on the wearable device 100. Examples of the wireless internet techniques may include WLAN (Wireless LAN) (Wi-Fi), Wibro (Wireless broadband), Wimax (World Interoperability for Microwave Access), HSDPA (High Speed Downlink Packet Access), GSM, CDMA, WCDMA, LTE (Long Term Evolution).

The wireless internet connection via Wibro, HSDPA, GSM, CDMA, WCDMA, LTE or like may facilitated by a mobile communication network. In this instance, the wireless internet module configured to implement wireless internet connection via the mobile communication network may be understood as one type of the mobile communication module.

The short range communication module refers to a module for short range communication. Examples of the short range communication may include Bluetooth, RFID (Radio Frequency Identification), (IrDA, infrared Data Association), UWB (Ultra Wideband), ZigBee and the like.

The location information module may be a module for acquiring the location of the wearable device 100. One typical example of the location information modules may be GPS (Global Position System). According to the current techniques, the GPS module applies trigonometry to information about the distances from three or more satellites and information about the precisely calculated information, only to calculate information about the 3D current location according to the latitude, the longitude and the height. The method is broadly used that the location and time is calculated by using three satellites only to correct an error of the calculated location and time information. In addition, the GPS module may calculate speed information by continuously calculating the current location in real time and then calculate the speed information based on the continuously calculated current locations.

Referring to FIG. 1, the input unit 120 is configured to input an audio signal or a video signal. The input unit 120 may include a camera 121, a microphone 122, a user input unit 123 and a touch sensor 124.

The camera 121 processes an image frame 160 including the still or motion image photographed by an image sensor in a video call or camera mode. The processed image frame 160 may be displayed on a wave guide 153. The image frame 160 processed in the camera 121 may be stored in the memory 135 or transmitted to an external device via the wireless communication unit 110. Two or more cameras 121 may be provided according to usage environments.

The microphone 122 may receive an external audio signal in a call mode, a record mode or a voice recognition mode and process the input audio signal into an electrical video data. In the call mode, the processed voice data may be converted into a type of data transmittable to a mobile communication base station via the mobile communication module and output. Diverse noise remove algorithms for removing the noise generated while the microphone 122 is receiving the external audio signal may be realized in the microphone 122.

When acquiring the still image, the camera 121 may extract information from the still image. When the camera 121 acquiring the motion pictures, the motion picture is configured of several still images and then it is an unnecessary process waste for the image recognition unit to acquire information from all of the still images and for the controller to process the acquired information. Moreover, if even unnecessary information is extracted and the extracted information is provided to the user, the user may feel uncomfortable in using the wearable device 100 used like glasses.

When the user presses a user input unit 123 provided in the frame 160 or inputs a voice command of acquiring image information, only the needed information may be extracted. Or, when the user is looking at the same object for a preset time period or more, the camera 121 may photograph the object for a preset time period or more to extract information.

Alternatively, when the user is approaching a specific object and the object occupies a large space of the user's view, it may be determined that the user is looking at the corresponding object. Accordingly, one object occupies a preset space or more of the image recognized by the camera 121, information about the object may be extracted.

It is difficult to provide the wearable device 100 with a keyboard but a button type user input unit 123 may be provided on the frame 160 to receive an input of the commands frequently used by the user. As one example, the frequently used commands may include a command of photographing the motion image viewed by the user, a command of extracting information from the motion image and a command of adjusting the audio output from the audio output unit 152.

A method of generating a signal by recognizing a physical pressure via a metal dome, a method of recognizing the user's touch via the touch sensor 124 and other diverse methods may be applied to the user input unit 123.

The sensing unit 140 may be configured to sense a current state and a peripheral environment of the mobile terminal 100. Examples of the sensing unit 141 may include a gyro sensor 141 and an acceleration sensor 142.

The gyro sensor 141 means a device configured to sense change in the tilting of the mobile terminal and extracts variation of an axis that is orthogonal with respect to x, y and z axes. The gyro sensor is called the angular velocity sensor. The gyro sensor may be configured to sense the rotational motion with respect each axis as the momentum and sense the tilting and shaking of the mobile terminal body.

A conventional gyro sensor is a top having three axes but a recent gyro sensor is the sensor minimized with an improved accuracy such as an optical gyro or a vibration gyro such that the recent gyro sensor may be loaded in a small electronic product such as a mobile terminal. Moreover, 6-axis sensor realized by a MEMS module may be used as the gyro sensor 141.

The gyro sensor 141 applied to the present invention is not limited thereto and includes all types of sensors that are capable of sensing the tilting and motion of the wearable device 100.

The acceleration sensor 142 is configured to a dynamic force such as the acceleration of the wearable device 100. The acceleration sensor 142 may also detect vibration, shocks and the like based on the variation in the acceleration. When an object with a mass is accelerated, a power is generated and variation in the generated power is sensed.

The proximity sensor 144 may be arranged in the frame 160 and configured to sense the object approaching the wearable device. The proximity sensor means the sensor which detects the presence of an object approaching a preset detection surface or located nearby based on a force of an electromagnetic field or an infrared ray, without a mechanical touch. The proximity sensor has a longer life span and a higher usability.

Examples of the proximity sensor include a transmission photoelectric sensor, a direct reflection photoelectric sensor, a mirror-reflection photoelectric sensor, a high-frequency oscillation proximity sensor, a capacitance proximity sensor, a magnetic proximity sensor and an infrared proximity sensor. When the touch screen is a capacitance type, the proximity of a pointer may be detected based on change in the electric field according to the approaching of the pointer. In this instance, the touch screen (or the touch sensor) may be categorized as the proximity sensor.

Next, the output unit 150 is configured to generate an output related with sight, hearing or touch and includes an image output unit 151 and an audio output unit 152.

The image output unit 151 is a device configured to provide the user with a motion image. The image output unit 151 may be integrally formed with the wearable device 100 or realized by mounting a bar type mobile terminal (e.g., a smart phone) including a display unit to the wearable device.

The image output unit 151 may provide the motion images with the user's left and right eyes, respectively, to provide the user with a stereo-scopic image. The image on one display unit is split into a left eye image and a right eye image or a pair of displays may be used.

The image output unit 151 may include at least one of a liquid crystal display (LCD), a thin film transistor-liquid crystal display (TFT LCD), an organic light-emitting diode (OLED), a flexible display, a 3D display and e-ink display.

The audio output unit 152 may output the audio data received from the wireless communication unit 110 in the call signal reception, the call or record mode, the voice recognition mode and the broadcasting reception mode or stored in the memory 135. The audio output unit 152 may also output an audio signal related with the functions performed in the wearable device 100 (e.g., a call signal receiving sound, a message receiving sound or the like). Such the audio output unit 152 may include a receiver, a speaker and a buzzer.

The wearable device 100 may be configured as a bone conduction type configured to transmit a sound to the user while worn on the head. A vibration module is provided in the area worn on the human head and configured to transmit a sound by vibrating the cranial bone.

Programs for the processing and controlling of the controller 130 may be stored in the memory 135 and the memory 135 may implement a function for temporarily storing the input/output data. The new input data may be stored in the memory 135 and the data stored in the memory before may be extracted and used. The memory 135 may be embedded and include an auxiliary storage device such as a SD card to expand the storage function.

The controller 130 may be implemented to typically control the overall operation of the wearable device 100. The controller 130 may transceive diverse signals or process the input data by controlling the wireless communication unit 110 or provide the user with information by controlling the image output unit 151 and the audio output unit 152.

The controller 130 in accordance with the present invention may extract information from the image acquired by the camera 121 and compare the extracted information with pre-stored information or store the extracted information in the memory 135 or extract the related information stored in the memory 135 and output the extracted information to the image output unit 151 or search for the related information on the internet.

The power supply unit 139 may be supplied the external power and an internal power by the control of the controller 130 to supply the power needed in actuating the components. Examples of the power supply unit 139 may include a battery, a connection port, a power supplier and a charge monitoring unit.

The various embodiments described herein may be realized in recording media which may be readable by a computer or a similar device thereto, using software, hardware or combination of the two.

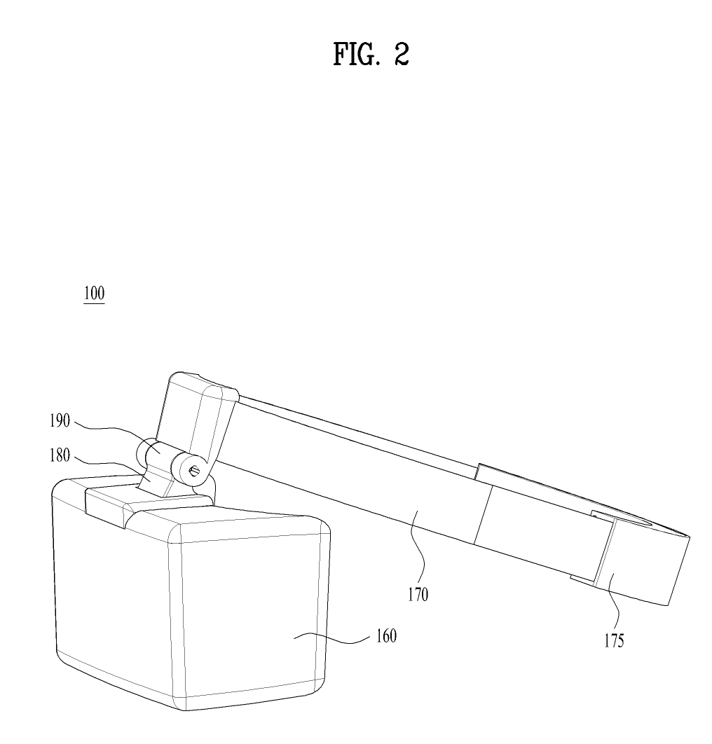

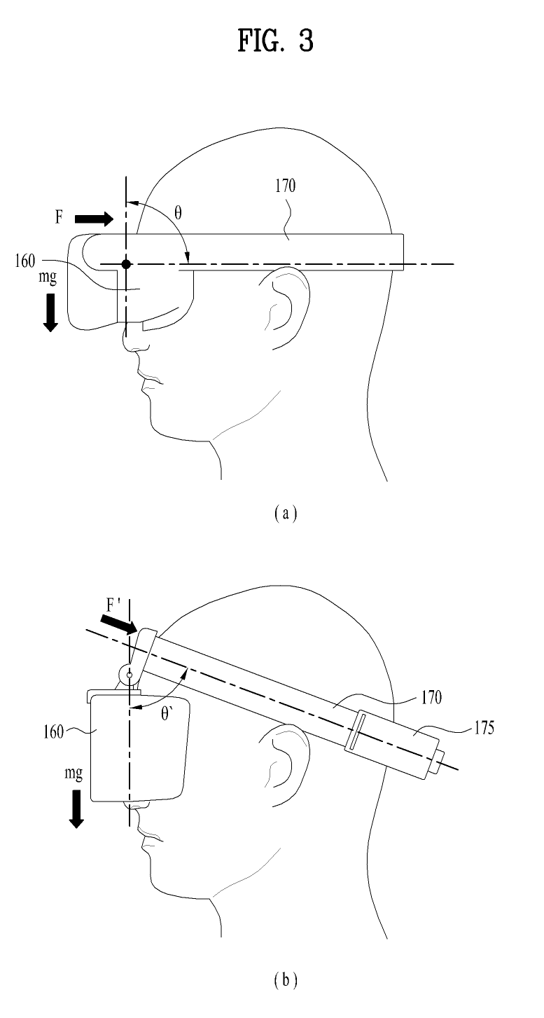

FIG. 2 is a perspective diagram illustrating the wearable device. FIG. 3 is a side view illustrating a state where a user is wearing a conventional wearable device and a state where a user is wearing the wearable device according to the present invention. The wearable device 100 according to the present invention is a HMD (Head Mount Display) device which provides the user's eyes with image information while being worn on the user's head.

The wearable device 100 may include a main body 160 arranged in front of the user's eyes and including the image output unit 151, the sensing unit and the controller; and a head band 170 provided to secure the main body 160 to the user's head. For easy explanation, the area which contacts with the user's face when the user is wearing the wearable device 100 may be a rear area and an area which is located in a direction of the user's sight.

The image output unit 151 loaded in the main body 160 may have a holder or stand to rest the smart phone when it is used with a display device such as a smart phone. In case of the embedded type, the image output unit 151 may include the display device directly.

The main body 160 is provided with the image output from the image output unit 151 in a state of being in close contact with the user's face, without the incoming light. Accordingly, the area in close contact with the face may have a curved portion curved along a curved line of the user's face as shown in FIG. 2. The main body 160 may further include a flexible material such as silicon to closely contact with the user's face.

The head band 170 may be connected to an upper portion of the main body 160 and connected from the user's forehead to the back side of the head in a ring shape. The head band of the conventional wearable device 100 is connected to the main body 160 along a lateral direction as shown in FIG. 3 (a) to reach the back side of the head past an upper portion of the ears. However, the head band 170 according to the present invention starts from the forehead to be worn on the head in a state of being tilted as shown in FIG. 3 (b).

The conventional head band 170 supports the weight (mg) of the main body 160 in a vertical direction (θ=90°) such that a corresponding force to the friction factor (mg/p) in a vertical direction with respect to the gravity has to be applied to secure the main body 160 without falling down.

When the head band 170 is arranged as tilted as θ′ as shown in FIG. 3 (b), the friction force (F) is changed into sin θ′/μ. sin θ′ is smaller than 1 and even the force which is as small as sin θ′ is needed in supporting the head band only to secure the head band more stably.

The head band 170 may use a hard material for the stable securing. When using the hard material, the length of the head band 170 is not changed and it is then difficult to adjust the length according to the user's head size. Accordingly, the head band 110 may further include a length adjusting unit 175. As shown in FIG. 2, the length adjusting unit 175 may be located in the area of the head band 175 located on the back side of the user's head or aside with respect to the back side.

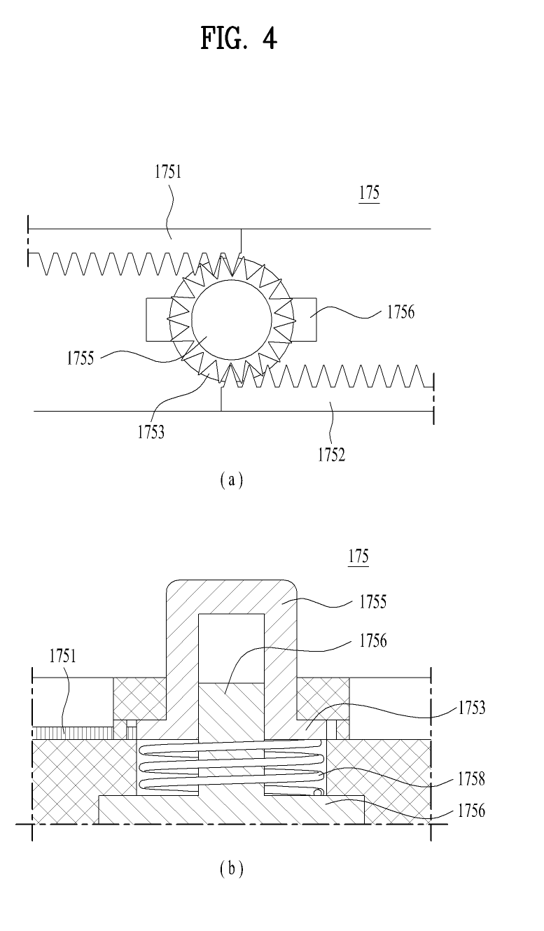

FIG. 4 is a perspective diagram illustrating the length adjusting unit provided in the wearable device 100. The areas of the head band 170 arranged in right and left sides with respect to the length adjusting unit 175 may be a first band and a second band.

The length adjusting unit 175 may include one or more rack gears 1751 and 1752 that are provided in one or more of the first and second bands; and a pinion gear 1753 having teeth configured to engage with the rack gears 1751 and 1752. When the pinion gear 1753 is rotated, the rack gears 1751 and 1752 may move linearly to adjust the length of the head band 170.

In the present embodiment, the first and second rack gears 1751 and the 1752 may be arranged in the first and second bands, respectively. the firs track gear 1751 and the second rack gear 1752 may be arranged in symmetry with respect to the pinion gear 1753 as shown in FIG. 4 (a) and movable symmetrically along the rotational direction of the pinion gear 1753 to increase or decrease the length of the head band 170.

A button unit 1755 may be further provided to allow the user to rotate the pinion gear 1753. as shown in FIG. 4, one side of the button unit 1755 may be coupled to one surface of the pinion gear 1753 and the other side may be projected outwardly with respect to the head band 170 to allow the user to hold and rotate the pinion gear 1753.

To allow the user to take off the wearable device 100 more easily, the pinon gear 1753 may be separated from the rack gears 1751 and 1752. As shown in FIG. 4 (b), a spring 1758 may be further provided in the other surface of the pinion gear 1753 such that the state of the engaging between the pinon gear 1753 and the rack gears 1751 and 1752 may be fixed by the elasticity of the spring 1758. Or, when the user presses the button unit 1755, the spring 1758 shrinks enough to separate the rack gears 1751 and 1752 from the pinon gear 1753 and the length of the head band 170 is increased. Accordingly, the user is able to take off the head band 170 easily only after pushing the button unit 1755 and the usability of the wearable device may be improved.

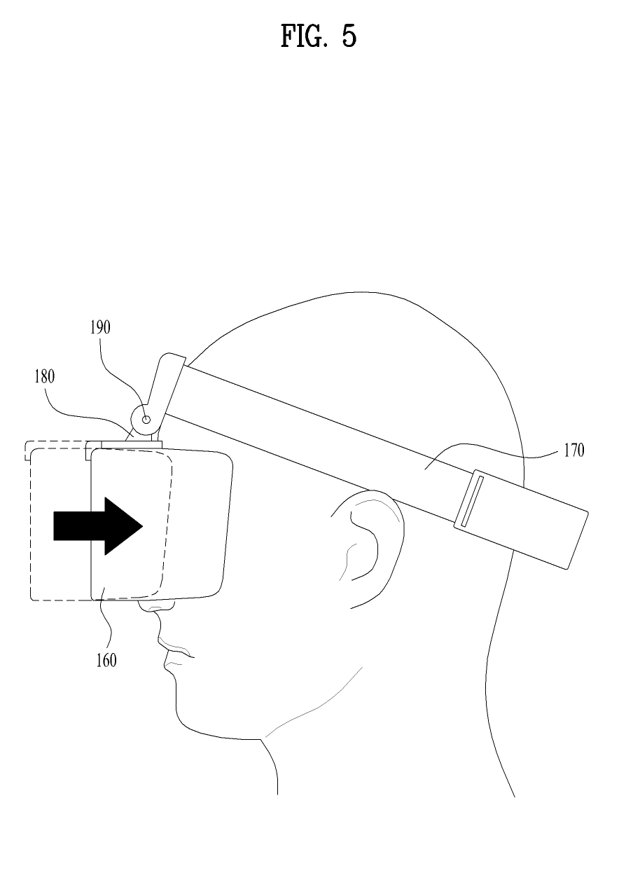

FIG. 5 is a diagram illustrating the structure that the main body 160 of the wearable device 100 is moving in a horizontal direction. The use of the head band 170 may stably secure the wearable device 100 to the user's head. However, the main body 160 may be closely in contact with or spaced apart from the user's face according whether the user has a bulging forehead or a flat forehead. To solve such a disadvantage, the wearable device 100 according to the present invention may further include a sliding unit 180 which is able to slide in a horizontal direction (or a back-and-forth direction) as shown in FIG. 5.

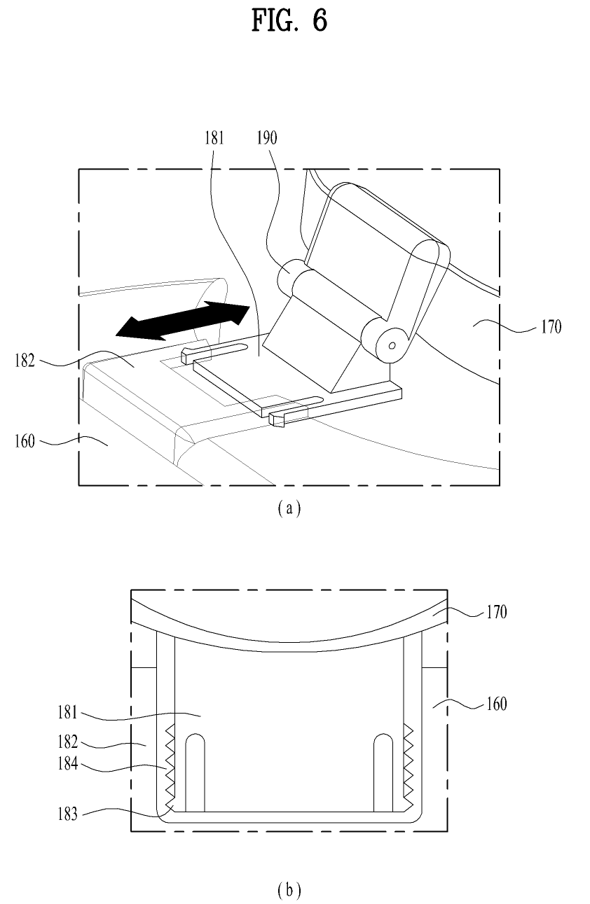

FIG. 6 is a diagram illustrating the sliding unit 180 of the wearable device 100. As shown in FIG. 5, to facilitate the back-and-forth motion of the main body 160, the wearable device 100 may further include a first sliding member 181 provided in the head band 170 and a second sliding member 182 provided in the main body 160. The second sliding member 182 is movable in relation with the first sliding member 181. The first sliding member 181 and the second sliding member 182 may be provided in the opposite positions. In other words, the second sliding member 182 may be provided in head band 170 and the first sliding member 181 may be arranged in the main body 160.

A hook 183 formed in the first sliding member 181 may be movable along a hook groove 184 formed in the second sliding member 182 in a horizontal direction. A plurality of hook grooves 184 may be serially formed in the horizontal direction. The hook 183 and the hook grooves 184 may be curved to facilitate the motion of the hook 183 into a neighboring one of the hook grooves.

The wearable device 100 according to the present invention may locate the main body 160 in close contact with the user's face, using the sliding unit 180, and then prevent external light from coming into the wearable device 100.

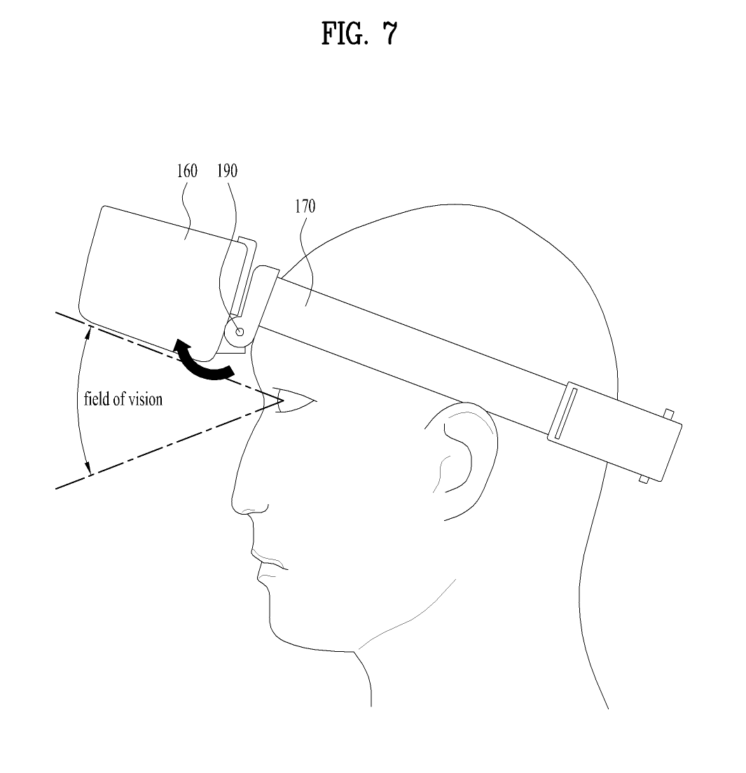

FIG. 7 is a diagram illustrating one embodiment of the main body 160 which is rotating along the movement of a hinge unit 190. In case the sight securement is needed while the user is wearing the wearable device 100, the user has to take off the wearable device 100 and re-wear it again uncomfortably. To solve the discomfort, the wearable device 100 may include a hinge unit 190 such that the user can separate the main body 160 from the eyes to secure the sight and easily put on the main body 160 again.

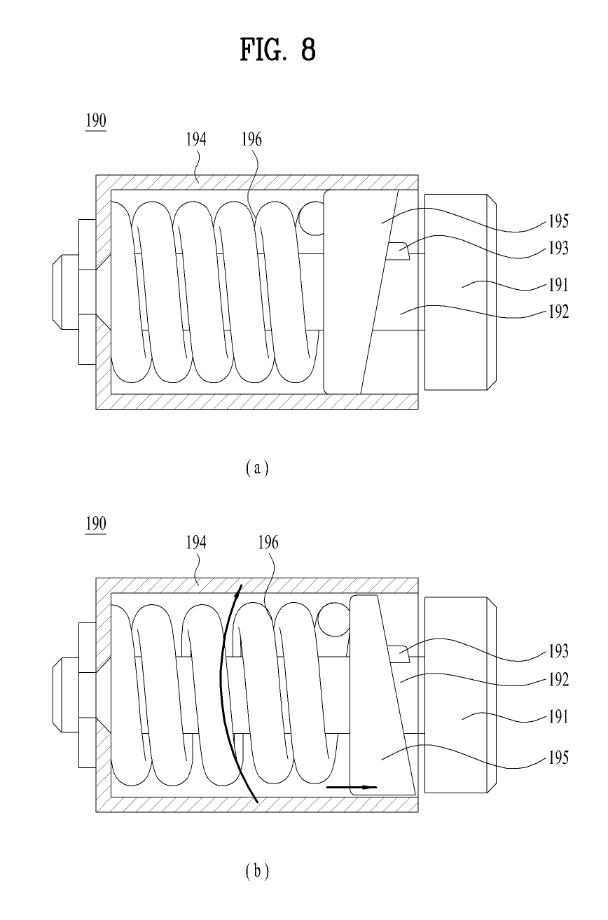

FIG. 8 is a perspective diagram illustrating one embodiment of the hinge unit 190 provided in the wearable device 100. The hinge unit 190 includes a hinge head 191, a hinge shaft 192, a hooking protrusion 193, a hinge housing 194, a cam member 195 and a elastic member 196.

Some area of the hinge unit 190 may be coupled to the head band 170 and the other area may be coupled to the main body 160 such that a relative angle of the main body 160 may change. The hinge unit 190 according to the present invention is not directly coupled to the main body 160 but coupled to the head band 170 and the first sliding member 181 mentioned above. However, even if it is directly coupled to the main body 160, the same result may be achieved.

Alternatively, the hinge unit 190 may be arranged between the second sliding member 182 and the main body 160. Even in this instance, the angle between the main body 160 and the head band 170 may change just like the case where it is coupled to the main body 160 and the head band 170. The embodiments of the present invention include that example.

The hinge head 191, the hinge shaft 192 projected from the hinge head 191 and the hooking protrusion 193 projected from a lateral surface of the hinge shaft 192 are moving together. The hinge head 191 is coupled to the head band 170 and the head band 170 is fixed when the hinge unit 190 is rotating. Accordingly, the positions of the hinge head 191, the hinge shaft 192 connected to the hinge head 191 and the hooking protrusion 193 are fixed.

The hinge housing 194 is coupled to the main body 160 (the first sliding member 181 in the present embodiment) and rotated together when the main body 160 is rotated as shown in FIG. 7. The elastic member 196 provided in the hinge housing 194 has one side arranged in the hinge housing 194 and the other side in which the cam member 195 is provided.

The cam member 195 is circular-shaped and has a variable thickness. One surface of the cam member 195 is not flat so that the cam member 195 may have an inclined surface 1953. As shown in FIG. 8, a through-hole may be formed in a center of the cam member 195 and the hinge shaft 192 penetrates the through-hole. The cam member 195 may be movable in a direction in which the hinge shaft 192 of the hinge housing 194 is extended, while it is rotatable together with the hinge shaft 192. The hooking protrusion 193 may face the inclined surface 1953 of the cam member 195. The location of the inclined surface 1953 of the cam member 195, which faces the hooking protrusion when the hinge housing 194 is rotated together with the main body 160, is variable. As the location of the hooking protrusion 193 is fixed, the cam member 195 is moved in a direction of the hinge shaft 192 along the rotation of the cam member 195 and the elastic member 196 is compressed or tensioned.

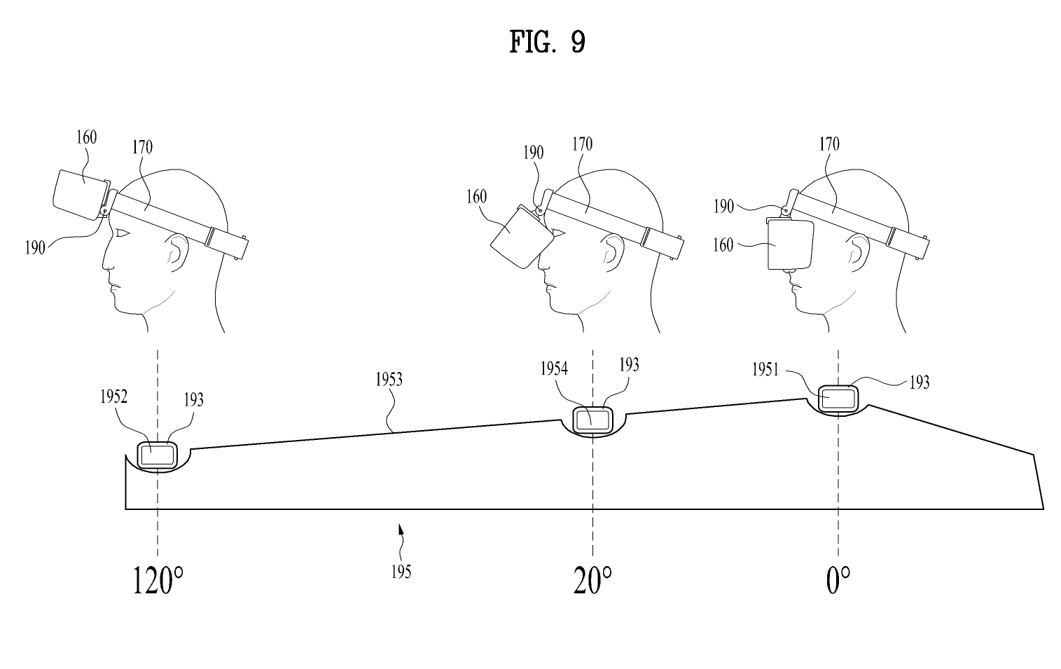

FIG. 9 is a diagram illustrating the location relation between the hooking protrusion 193 and the cam member 195 according to the embodiment of the hinge unit 190. The drawing is a development view illustrating that the surface having the cam member 195 and the hooking protrusion 193 to face each other develops 360 degrees. The angle means the location of the main body 160 in a state where the main body 160 is worn on the user's face. The case where the location of the main body 160 is changed in a range of 120 degrees may be exemplified.

The thickest area of the cam member 195 refers to a first area 1951 and the thinnest area refers to a second area 1952. When the hooking protrusion 193 is located in the first area 1951, the elastic member 196 is most compressed (see FIG. 8 (a)). When the hooking protrusion 193 is located in the second area 1952, the elastic member 196 is most tensioned (see FIG. 8 (b)).

When the elastic member 196 is changed from the tensioned state into the compressed state, an additional force which is as strong as the elasticity of the elastic member 196 is needed. In the opposite case, the force that is as strong as the elasticity of the elastic member 196 is less needed. To change the location of the main body 160 from 0 degree to 120 degrees, the user has to lift the main body 160 and apply a force that is as strong as the weight of the main body 160.

To supplement the force for lifting the main body 160, the elastic member 196 is transformed to be tensioned when the location of the main body is changed from 0 degree to 120 degrees. In other words, the hinge unit 190 is changed from a state of FIG. 8 (a) to a state of FIG. 8 (b). The hooking protrusion 193 is located in the first area 1951 in the state of FIG. 8 (a) and in the second area 1952 in the state of FIG. 8 (b).

The location of the main body 160 has to be fixed such that the elasticity of the elastic member 196 may support the weight of the main body 160, to allow the user not to hold the main body 160 when the hooking protrusion 193 is located in the first area 1951. Moreover, a hooking groove may be further provided to prevent the hooking protrusion 193 located in the first area 1951 from moving along the inclined surface 1953 of the cam member 195 unintentionally. The hooking groove is formed even in the second part 1952 to fix the main body 160 from being lifted or moved by the elasticity of the elastic member 196.

A hooking groove may be additionally provided in a third area (e.g., 20 degrees) located between the first part 1951 and the second area. Accordingly, the main body 160 may not be bumped into the user's face when the state of the main body 160 is changed into 0 degree.

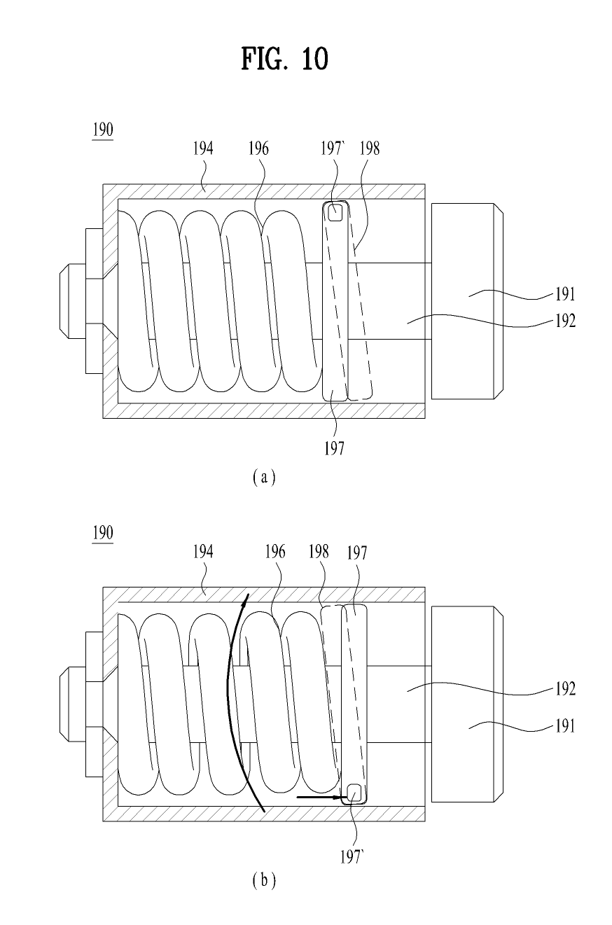

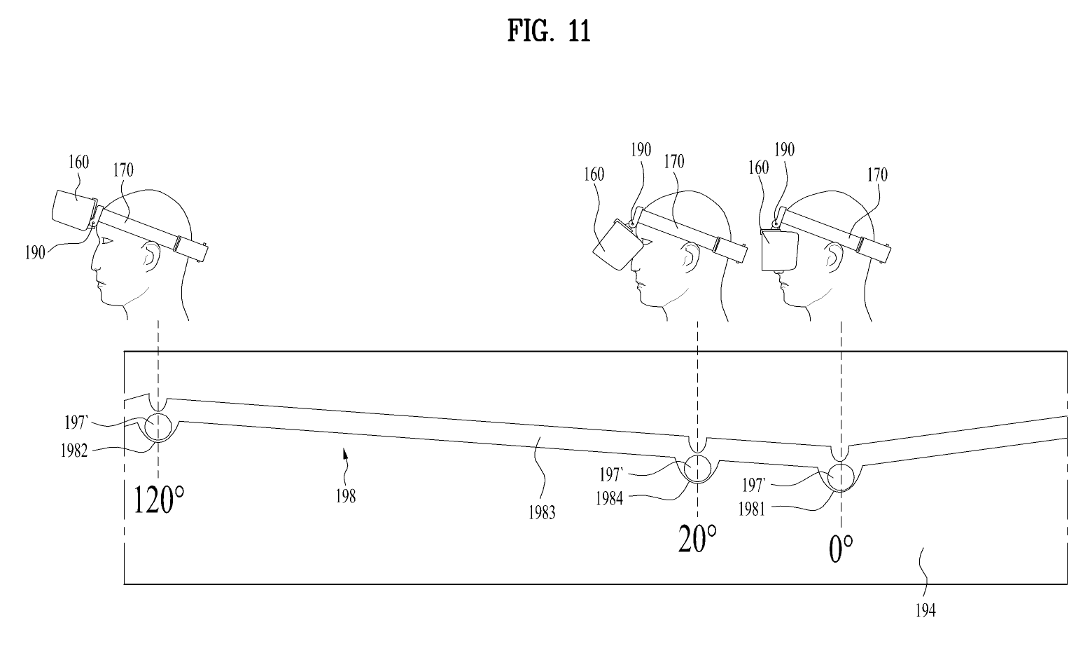

FIG. 10 is a perspective diagram illustrating another embodiment of the hinge unit 190 of the wearable device 100. FIG. 11 is a diagram illustrating a location relation between a hooking protrusion and a cam line 198 of the wearable device 100. Instead of the cam member 195 having a variable thickness, a washer 197 having a consistent thickness may be used to adjust the length of the elastic member 196. The washer 197 is fixed to the hinge shaft 192 while it is movable along the hinge shaft 192.

The hinge head 191, the hinge shaft 192, the elastic member 196 and the hinge housing 194 are similar to the above-noted embodiment. Instead of the cam member 195, the washer 197 may be used and a hooking protrusion 197′ may be projected from the washer 197 to be movable along a slope of a cam line formed in an inner surface of the hinge housing 194, which is different from the above-noted embodiment.

The cam line 198 is formed in an inner surface of the hinge housing 194 in an oblique groove shape. When the main body 160 is rotated, the location of the hooking protrusion 197′ projected from the washer 197 is changed along the cam line 198 and the washer 197 is then moved along the hinge shaft 192.

Referring to FIG. 11, the cam line 198 has a similar slope to the inclined surface 1953 of the cam member 195 mentioned above and hooking grooves may be formed in a first area 1981, a second area 1982 and a third area 1984 of the cam line 198 to fix the location of the main body at locations of 0 degree, 20 degrees and 120 degrees.

In case the location of the min body 160 is changed by using the hinge unit 190, the controller 180 may control the image output unit 151 to provide a motion image when the main body 160 is located in front of the user's eyes and to pause the supply of the motion image when the main body 160 is moved towards the user's forehead.

The location of the main body 160 may be sensed by using a proximity sensor or an IR sensor provided in an area towards the user's face. Alternatively, a rotational angle of the hinge unit 190 is sensed by a sensor having a switch configured to be pressed along the rotation of the hinge unit 190 and the location of the main body 160 may be indirectly sensed.

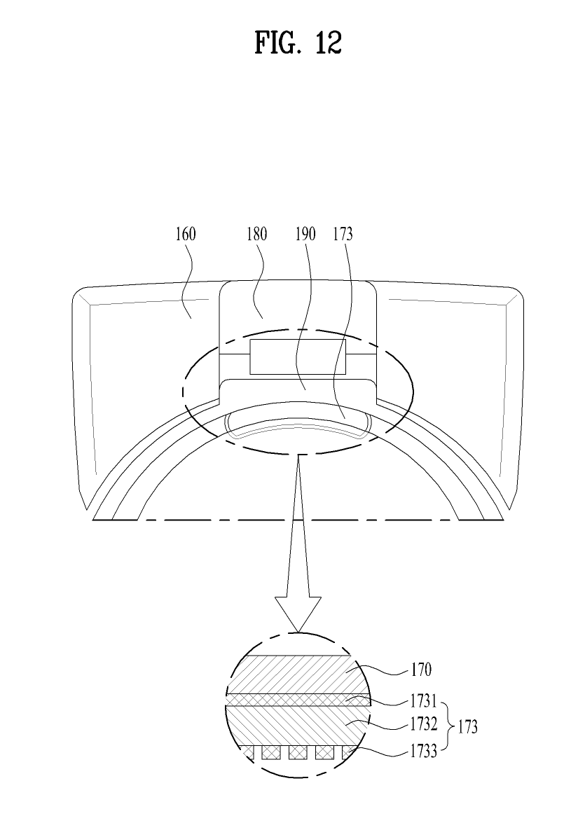

FIG. 12 is a diagram illustrating a forehead pad provided in the wearable device. The weight of the main body 160 is supported at the user's forehead. Accordingly, a flexible pad 173 may be further provided to reduce the pressure applied to the forehead of the head band 170.

The flexible pad 173 may include a flexible foam 1732 made of a flexible material to be transformed according to the shape of the user's forehead; a fabric layer 1733 attached to an area which will directly contacts with the user's forehead.

The forehead frequently sweats and a Velcro 1731 detachable from the head band 170 to be washed may be further provided. The wearable device 100 may have a multi-layered structure configured of the fabric layer 1733, the flexible foam 1732 and the Velcro 1731. Each of the layers may be bonded by using a thermocompression bonding method.

As described above, the wearable device 100 according to the present invention may allow the user to easily secure the sight and then minimize the discomfort that the user has to put on and take off the wearable device.

Furthermore, the wearable device 100 may adjust the size of the head band 170 according to the size or shape of the user's head and prevent external light from coming into the wearable device and disturbing the appreciation of the motion image by closely contacting with the user's face. Accordingly, the sense of the wearing may be enhanced.

As the present features may be embodied in several forms without departing from the characteristics thereof, it should also be understood that the above-described embodiments are not limited by any of the details of the foregoing description, unless otherwise specified, but rather should be considered broadly within its scope as defined in the appended claims, and therefore all changes and modifications that fall within the metes and bounds of the claims, or equivalents of such metes and bounds, are therefore intended to be embraced by the appended claims.

1. A wearable device comprising:
a head band formed in a ring shape;
a main body coupled to one side of the head band;
an image output unit loaded in the main body and configured to provide a user with an image; and
a hinge unit provided between the main body and the head band,
wherein the main body is rotatable with respect to the hinge unit and selectively covers the user's eyes.

2. The wearable device of claim 1, wherein the hinge unit comprises,
a elastic member provided to supplement the rotation of the main body when the main body is rotated in a first direction that becomes farther from the user's eyes.

3. The wearable device of claim 2, wherein
the hinge unit comprises,
a hinge head coupled to one of the head band and the main body;
a hinge shaft extended from the hinge head;
a washer coupled to the hinge shaft and movable along a direction of the hinge shaft;
a hinge housing coupled to the other one of the head band and the main body and having the hinge shaft and the washer arranged therein;
the elastic member provided in the hinge housing and having one side that faces the hinge housing and the other side that faces the washer;
a cam line formed in the hinge housing in an oblique groove shape; and
a hooking protrusion projected from an outer surface of the washer and provided to be inserted in the cam line and move along the cam line, and
the length of the elastic member is adjustable while the washer is moving along the hinge shaft as the location of the hooking protrusion is changed in the cam line.

4. The wearable device of claim 3, wherein the cam line comprises,
a first area and a second area having an inclined surface with a continuous surface and a hooking groove, and
when the hinge unit is rotated in a first direction, the location of the hooking protrusion is changed from the first area into the second area, and
when the hinge unit is rotated in a second direction that is opposite to the first direction, the location of the hooking protrusion is changed from the second area into the first area.

5. The wearable device of claim 2, wherein the hinge unit comprises,
a hinge head coupled to one of the head band and the main body;
a hinge shaft extended from the hinge head;
a hooking protrusion projected from the hinge shaft;
a hinge housing coupled to the other one of the head band and the main body and having the hinge shaft and the washer arranged therein;
a cam member comprising an inclined surface formed in a surface contacting with the hooking protrusion and movably coupled to the hinge housing along the hinge shaft; and
a elastic member provided in the hinge housing and having one side that faces the hinge housing and the other side that faces a cam member, and
the length of the elastic member is adjustable while the cam member is moving along the hinge shaft as the location of the hooking protrusion is changed in the inclined surface of the cam member.

6. The wearable device of claim 5, wherein the cam member has a disc-shape having the inclined surface formed in one surface of the cam member and the elastic member coupled to the other side, and
a hinge hole is formed in a center of the cam member to allow the hinge shaft to penetrate.

7. The wearable device of claim 5, wherein the inclined surface of the cam member comprises a first area that is high in a direction of one surface and a second area that is low, and
when he hinge unit is rotated in a first direction, the location of the hooking protrusion is changed from the first area into the second area, and
when the hinge unit is rotated in a second direction that is opposite to the first direction, the location of the hooking protrusion is changed from the second area into the first area.

8. The wearable device of claim 7, wherein the cam member comprises an inclined surface having a continuous surface and a hooking groove, and
the hooking groove is formed in at least one of the first and second areas.

9. The wearable device of claim 8, wherein one or more hooking grooves are additionally formed between the first area and the second area.

10. The wearable device of claim 1, further comprising:
a proximity sensor provided in the main body and configured to sense whether the user's face is located near the main body; and
a controller implemented to control image output unit to pause image output unless the proximity sensor senses the user's face and to continue the image output when the proximity sensor senses the user's face.

11. The wearable device of claim 1, further comprising:
a first sliding member coupled to one of the main body and the hinge unit; and
a second sliding member coupled to the other one of the main body and the hinge unit,
wherein the second sliding member is able to relatively slide with respect to the first sliding member in a third direction.

12. The wearable device of claim 11, further comprising:
a hook formed in the first sliding member; and
a plurality of hook grooves formed in the second sliding member and arranged in the third direction,
wherein when the user applies a force to the main body in the third direction, the hook is coupled to one neighboring one of the hook grooves and moves in the third direction.

13. The wearable device of claim 1, wherein the head band further comprises a first band; a second band; and a length adjusting unit provided to adjust a gap between the first band and the second band, and
the length adjusting unit comprises,
a rack gear coupled to one or more of the first and second bands; and
a pinion gear provided to engage with the rack gear and configured to convert the rotation motion into a linear motion.

14. The wearable device of claim 13, wherein the rack gear comprises,
a first rack gear coupled to the first band and one side of the pinion gear; and
a second rack gear coupled to the second band and the other side of the pinion gear, and
the first rack gear and the second rack gear are movable in symmetry.

15. The wearable device of claim 13, wherein the length adjusting unit further comprises,
a button unit projected from one surface of the pinion gear and exposed outside the head band; and
a spring provided in the other surface of the pinion gear, and
when the user presses the button unit, the pinion gear is separated from the rack gear and the length of the head band is increased, and
unless the user presses the button unit, the pinion gear is re-coupled to the rack gear by the elasticity of the spring.

16. The wearable device of claim 15, further comprising:
a flexible pad that is detachable from the head band,
wherein the flexible pad comprises,
a Velcro that is detachable from the head band;
a flexible foam having elasticity; and
a fabric pad provided to contact with the user's forehead.
